(19) United States
(12) Patent Application Publication
(10) Pub. No.: US 2026/0143043 A1
(43) Pub. Date: May 21, 2026

(54) RELAY DEVICE, CONTROL METHOD THEREOF, AND STORAGE MEDIUM

(71) Applicant: CANON KABUSHIKI KAISHA, Tokyo (JP)

(72) Inventor: SHOHEI BABA, Tokyo (JP)

(21) Appl. No.: 19/361,564

(22) Filed: Oct. 17, 2025

(30) Foreign Application Priority Data
Nov. 18, 2024 (JP) 2024-200317

(51) Int. Cl. H04L 67/561; H04L 41/0816; H04L 43/0817

(52) U.S. Cl. CPC H04L 67/561; H04L 41/0816; H04L 43/0817

(57) ABSTRACT

A monitoring device having a proxy server function of relaying communication between a service and a device confirms whether a network environment of the device is a network environment capable of using a proxy scheme for receiving the service with the proxy server function and validly sets a re-registration process for re-registering a target device as a device having a self-monitoring function with the service when the network environment is the network environment capable of using the proxy scheme. The monitoring device determines whether a device using a polling scheme for receiving the service without using the proxy server function of the monitoring device has the self-monitoring function. The monitoring device performs the re-registration process for re-registering a device determined to have the self-monitoring function as the device having the self-monitoring function with the service when the re-registration process is validly set.

### BACKGROUND

### FIELD OF THE TECHNOLOGY

This disclosure relates to a relay device, a control method thereof, and a storage medium.

### DESCRIPTION OF THE RELATED ART

Recently, various devices have been connected to a server and a cloud service via a network. There is a structure known as the Internet of Things (IoT) for providing a high-value-added service to a device connected to a cloud service or the like via a network. The IoT encompasses two major systems. The first system is a device management system including a device management service for managing a connected device, a storage service for managing collected device information, and authentication and authorization services having authentication and authorization functions for securely connecting the device to a cloud service. The second system is a contract service provision system that works in conjunction with the device management system to provide various types of services such as a device maintenance service and a reporting service. Japanese Patent Laid-Open No. 2017-126191 discloses a system in which a certain device substitutes for another device within the same network and registers the device as a client in an authentication and authorization server.

As described in Japanese Patent Laid-Open No. 2017-126191, there are several cases in which a certain device controls a registration process in place of another device. For example, there is a case where a monitoring device that integrally manages a plurality of devices having a self-monitoring function via its own proxy function issues a registration instruction to a device having the self-monitoring function under the monitoring device. Moreover, there is a case where the monitoring device substitutes for and registers a plurality of devices that do not have the self-monitoring function.

However, because a function capable of being provided by a cloud service is different between a device having the self-monitoring function and a device that does not have the self-monitoring function, device management and registration methods may be different on the cloud service side. Moreover, the function is not generally limited to a remote monitoring function from the monitoring device. Therefore, because the device having the self-monitoring function can receive more services, it is preferable for the device to preferentially use the self-monitoring function. In a case where the device that does not have the self-monitoring function becomes the device having the self-monitoring function by updating firmware, the device registration must be switched (re-registration) on the cloud service side when the self-monitoring function is validated. Moreover, when the operation is switched to one using the self-monitoring function, the number of connection destination services may increase, and therefore the customer’s network environment settings also need to be reviewed.

### SUMMARY

The present disclosure provides a relay device that improves the security of device registration with a device management service according to the device’s self-monitoring function.

According to the present disclosure, there is provided a relay device having a proxy server function of relaying communication between a device management service and a device, the relay device comprising: a setting unit configured to confirm whether a network environment of the device is a network environment capable of using a proxy scheme for receiving the device management service with the proxy server function of the relay device and validly set a re-registration process for re-registering a target device as a device having a self-monitoring function for the device management service with the device management service when the network environment is the network environment capable of using the proxy scheme; a determination unit configured to determine whether a device using a polling scheme for receiving the device management service without using the proxy server function of the relay device has the self-monitoring function; and a registration unit configured to perform the re-registration process for re-registering a device determined to have the self-monitoring function as the device having the self-monitoring function with the device management service when the re-registration process is validly set.

Features of the present disclosure will become apparent from the following description of embodiments with reference to the attached drawings. The following description of embodiments is provided by way of example.

### BRIEF DESCRIPTION OF THE DRAWINGS

FIG. 1 is an explanatory diagram of an overall configuration of a device management system.

FIG. 2 is a diagram showing an example of a hardware configuration of an image forming device.

FIG. 3 is a diagram showing an example of a hardware configuration of a monitoring device and a management server.

FIG. 4 is a diagram showing an example of a software configuration of the image forming device.

FIG. 5 is a diagram showing an example of a software configuration of the monitoring device.

FIG. 6 is a sequence diagram showing an example of a registration determination process for the image forming device.

FIG. 7 is a sequence diagram showing an example of a registration process for the image forming device that does not have a self-monitoring function.

FIG. 8 is a diagram showing an example of a device management information table managed by the monitoring device.

FIGS. 9A and 9B are diagrams showing examples of a device management table and an agent management table managed by a device management server.

FIG. 10 is a diagram showing an example of a client management table managed by an authentication and authorization server.

FIG. 11 is a diagram showing an example of a device registration key management table managed by the authentication and authorization server.

FIG. 12 is a diagram showing an example of an activation code management table managed by the authentication and authorization server.

FIG. 13 is a diagram showing an example of a credential management table managed by the authentication and authorization server.

FIG. 14 is a sequence diagram showing an example of a registration process for the image forming device having the self-monitoring function.

FIG. 15 is a flowchart showing a device registration status confirmation process in the monitoring device.

FIG. 16 is a flowchart showing a communication test result confirmation process in the monitoring device.

FIG. 17 is a flowchart showing a re-registration determination process for the image forming device in example 1.

FIG. 18 is a flowchart showing the re-registration determination process for the image forming device in example 1.

FIG. 19 is a diagram showing an example of a device registration task management table.

FIG. 20 is a diagram showing an example of a device registration task setting screen.

FIG. 21 is a diagram showing an example of a device detail screen.

FIG. 22 is a flowchart showing a re-registration process for the image forming device.

FIG. 23 is a flowchart showing a re-registration determination process for the image forming device in example 2.

FIG. 24 is a flowchart showing the re-registration determination process for the image forming device in example 2.

FIG. 25 is a flowchart showing a re-registration process for the image forming device in example 3.

### DESCRIPTION OF THE EMBODIMENTS

### (Example 1)

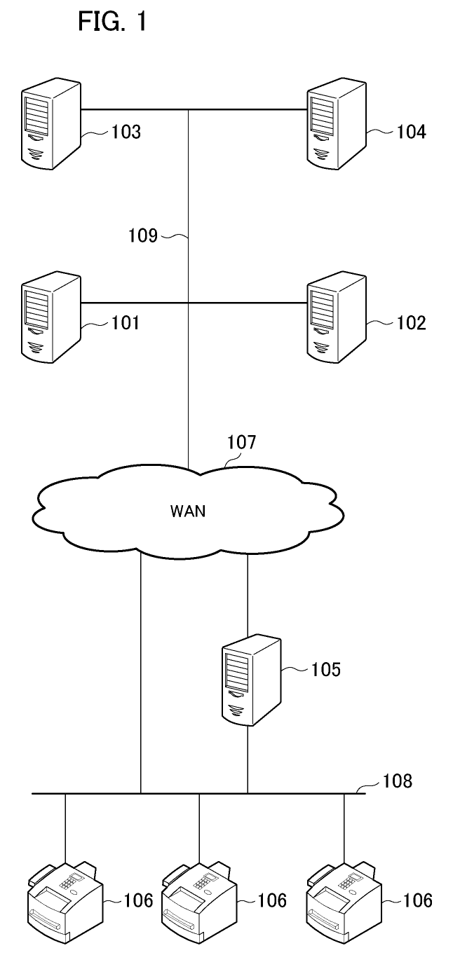

FIG. 1 is an explanatory diagram of an overall configuration of a device management system that manages devices. In the present example, an example in which a device management service is configured to manage an image forming device 106 that is a network device via a network will be described. The device management system includes an image forming device 106, which is a management target, a monitoring device 105, which is a relay device having a proxy server function, and a group of servers that provide the device management service to the image forming device 106 via a network. The number of image forming devices 106 may be two or more. The image forming devices 106 are connected via the network.

The image forming device 106 is a network device that receives various types of services from the group of servers in the system. The image forming device 106 is, for example, a multifunction peripheral (MFP) having a printing function and a scanning function. The image forming device 106 receives print data received via the network using the printing function and performs a printing process on actual paper or the like using known printing technologies such as electrophotography and inkjet technology. The image forming device 106 reads a paper document via a scanner according to a scanning function and converts the read paper document into image data. In addition, a network device can be any device capable of communication, and may be, for example, a single-function printer with only a printing function, a scanner, a 3D printer, a laptop computer, a smartphone, a smart home appliance, or the like.

The monitoring device 105 monitors the image forming device 106, which is the network device, via the network. The monitoring device 105 is connected between the server group and the image forming device 106. The monitoring device 105 collects data from the image forming device 106 and transmits the collected data to the server. Moreover, the monitoring device 105 in the present example has a proxy server function and functions as a relay device that relays communications between the image forming device 106 and the server group. In addition, some of the image forming devices 106 serving as management targets of the device management service may function as the monitoring device 105.

The server group manages data collected by the monitoring device 105 and the image forming devices 106 and the monitoring device 105 serving as management targets, and provides the device management service. The server group in the present example includes, for example, a device management server 101, an authentication and authorization server 102, a resource server 103, and a service providing server 104. The device management server 101 is an information processing device that manages information about the image forming device 106 and the monitoring device 105 that are targets of various types of services.

The authentication and authorization server 102 is an information processing device that provides authentication and authorization functions for securely connecting the image forming device 106 and the monitoring device 105 to various types of servers. The authentication and authorization server 102 performs authentication and authorization using, for example, a general OAuth mechanism. The authentication and authorization server 102 registers each device (the image forming device 106 or the monitoring device 105) as a client linked to a specific tenant and issues a token to the client. Using the issued token, each device (the image forming device 106 or the monitoring device 105) accesses various types of servers.

The resource server 103 is an information processing device that manages information collected from the image forming device 106, which is primarily required to provide services. The service providing server 104 provides various types of services, such as a maintenance service and a reporting service, on the basis of various types of information about the image forming device 106 managed by the resource server 103. In addition, the functions of the server group may be realized by a virtual machine (cloud service) using resources provided by a data center including the information processing devices in addition to one or more information processing devices or a combination thereof.

The server group (the device management server 101, the authentication and authorization server 102, the resource server 103, and the service providing server 104) is connected to a local area network (LAN) 109. The image forming device 106 and the monitoring device 105 are connected to a LAN 108. The LANs 109 and 108 are connected to a wide area network (WAN) 107. In this way, the server group, the monitoring device 105, and the image forming device 106 are connected via the network. In addition, the network may be configured to enable data transmission and reception, and any communication method may be used. For example, it is only necessary for the network to be configured as a LAN, a WAN, a cellular network such as LTE or 5G, a wireless network, a telephone line, a dedicated digital line, or a combination thereof.

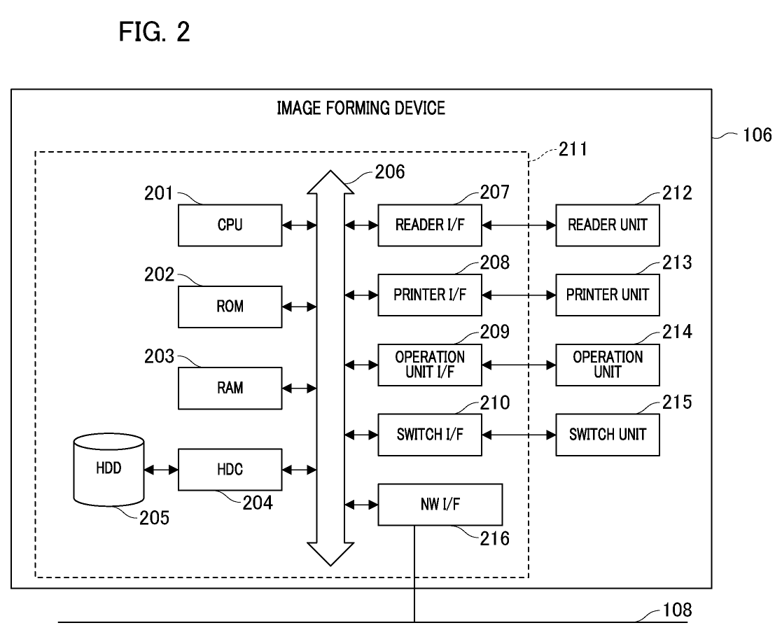

FIG. 2 is a diagram showing an example of a hardware configuration of the image forming device 106. The image forming device 106 includes an overall control unit 211, a reader unit 212, a printer unit 213, an operation unit 214, and a switch unit 215. The overall control unit 211 includes a central processing unit (CPU) 201, a read-only memory (ROM) 202, a random-access memory (RAM) 203, a hard disk controller (HDC) 204, a hard disk drive (HDD) 205, a reader I/F 207, a printer I/F 208, an operation unit I/F 209, a switch I/F 210, and a network (NW) I/F 216. The CPU 201, the ROM 202, the RAM 203, the HDC 204, the reader I/F 207, the printer I/F 208, the operation unit I/F 209, the switch I/F 210, and the NW I/F 216 are connected via a system bus 206.

The CPU 201 generally controls the entire image forming device 106. The CPU 201 generally controls each device connected to the system bus 206 by executing software that controls the image forming device 106 stored in the ROM 202 or the HDD 205. The ROM 202 is a memory dedicated to reading data, and stores, for example, the basic control program for the image forming device 106. The RAM 203 is a memory from and to which data can be read and written. The RAM 203, for example, functions as a work area for the CPU 201 and the like.

The HDC 204 controls the HDD 205. The HDD 205 is an example of a storage device and stores various types of programs, data, and the like. Although an example in which the image forming device 106 includes the HDD 205 as a storage device has been described in the present example, the present disclosure is not limited thereto. For example, other storage devices such as an SSD and a disk drive for loading external media may also be used.

The reader I/F 207 is an interface that connects the reader unit 212 and the system bus 206 and controls the reader unit 212. The reader unit 212 reads an original document as an image and generates image data. The generated image data is used for various types of processes such as a process for outputting the image data to the printer unit 213, a process for storing the image data in the HDD 205, and a process for transmitting the image data to a host computer connected to the network 217 via the NW I/F 216, in accordance with an instruction from a user.

The printer I/F 208 is an interface that connects the printer unit 213 and the system bus 206 and controls the printer unit 213. The printer unit 213 prints the original document read by the reader unit 212 and the image data stored in the HDD 205 onto a storage medium (e.g., paper). Moreover, the printer unit 213 receives print jobs from a host computer connected to the network 217 via the NW I/F 216 and prints the image data on the basis of the print jobs.

The operation unit I/F 209 is an interface that connects the operation unit 214 and the system bus 206 and controls the operation unit 214. The operation unit I/F 209 controls a display on the operation unit 214 and a user input from the operation unit 214. The operation unit 214 performs the display for the user and the reception of an operation from the user. The operation unit 214, for example, may include a display and operation buttons or may include a touch panel. By associating input coordinates on the touch panel with display coordinates, it is possible to configure a GUI as if the user is directly operating the screen displayed on the touch panel.

The switch I/F 210 is an interface that connects the switch unit 215 and the system bus 206 and controls the switch unit 215. The switch unit 215 has a switch for switching a power ON/OFF status of the image forming device 106 and the like. The NW I/F 216 is a communication interface that connects the image forming device 106 and a network (e.g., the LAN 108). The CPU 201 communicates with other information devices on the network via the NW I/F 216 and the network.

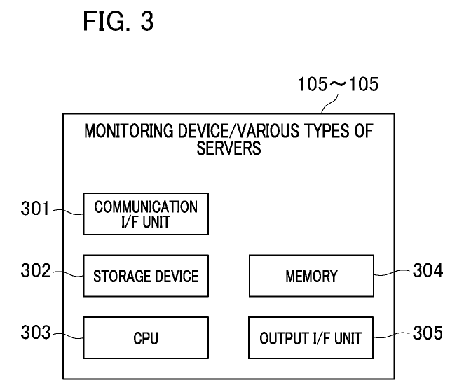

FIG. 3 is a diagram showing an example of a hardware configuration of the monitoring device 105. Moreover, the server group (the device management server 101, the authentication and authorization server 102, the resource server 103, and the service provider server 104) has a hardware configuration similar to that of the monitoring device 105. The monitoring device 105 has a hardware configuration similar to that of a general information processing device, and includes a CPU 303, a memory 304, a storage device 302, an operation I/F 305, and a communication I/F 301.

The CPU 303 of the monitoring device 105 controls the entire monitoring device 105. The CPU 303 loads a program from the storage device 302 into the memory 304 and executes the program to realize various types of control. The storage device 302 stores an operating system (OS), a program, management data, data collected from an external system and/or device, and the like. The memory 304 functions as a work area for the CPU 303 or the like. The operation I/F 305 outputs a result of executing various types of data and a program to an output device such as a connected display and receives an input from a connected input device. The communication I/F 301 is a network interface for communicating with the external system and/or device. The communication I/F 301 of the monitoring device 105, for example, is connected to the WAN 107 and the LAN 108.

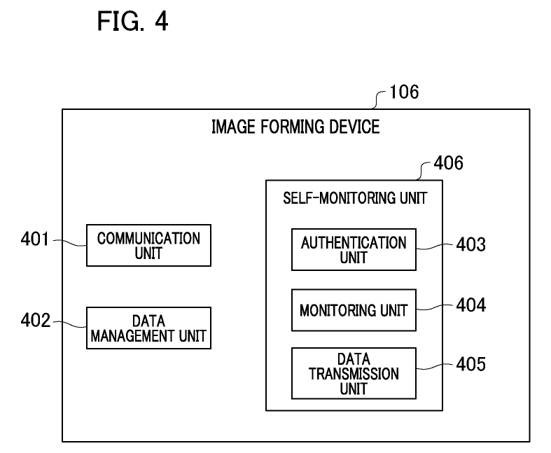

FIG. 4 shows an example of a software configuration of the image forming device 106. The image forming device 106 has a communication unit 401 and a data management unit 402. The communication unit 401 communicates with an external device such as the monitoring device 105. The data management unit 402 manages basic device information, various types of operation information, and the like. The basic device information includes, for example, a device name, a serial number, a product name, and the like. The various types of operation information include, for example, the number of printed pages, the remaining ink level, error information, and the like.

The image forming device 106 having the self-monitoring function has a self-monitoring unit 406. The self-monitoring function is a function of monitoring its own device, collecting operation information required for the device management service within its own device, and transmitting the operation information to various types of servers that provide the device management service. The self-monitoring unit 406 has an authentication unit 403, a monitoring unit 404, and a data transmission unit 405. The authentication unit 403 communicates with the authentication and authorization server 102 to register it as a client and acquire and manage a token. Moreover, the authentication unit 403 communicates with the monitoring device 105 in relation to settings required for monitoring, including a registration instruction for the authentication and authorization server 102. The monitoring unit 404 collects data required for self-monitoring and the like. The data transmission unit 405 transmits the data collected by the monitoring unit 404 to the resource server 103.

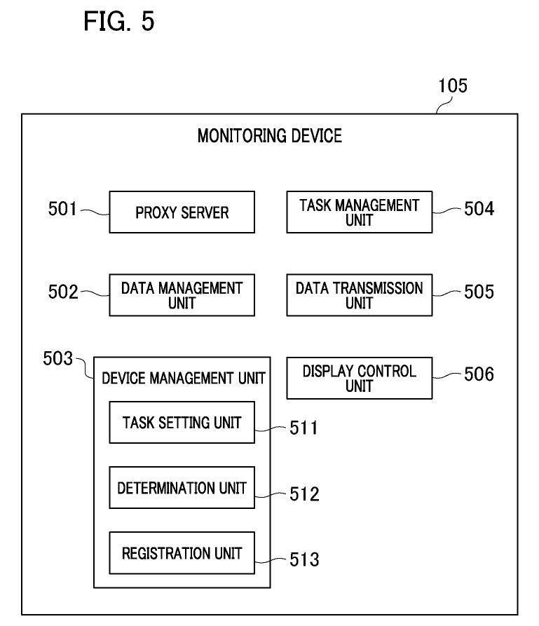

FIG. 5 shows an example of a software configuration of the monitoring device 105. The monitoring device 105 has a proxy server 501, a data management unit 502, a device management unit 503, a task management unit 504, a data transmission unit 505, and a display control unit 506. The proxy server 501 aggregates communications from the image forming devices 106 having the self-monitoring function and relays communications between the image forming devices 106 and the device management service. The data management unit 502 manages device information necessary for a device monitoring process. For example, the data management unit 502 manages status information indicating whether or not a device is its own management target. Moreover, the data management unit 502 manages monitoring data acquired from the image forming devices 106 that do not have the self-monitoring function and the like.

A mechanism by which a server group acquires device data includes a polling scheme and a proxy scheme. In the polling scheme, the monitoring device 105 collects data from the image forming device 106 through periodic polling and transmits the collected data to the server group. In the polling scheme, the monitoring device 105 acquires data from the image forming device 106 through periodic polling and transmits the acquired information to a server within the server group to manage the devices. In the proxy scheme, the monitoring device 105 serves as a proxy server and collects data from the image forming device 106. In the proxy scheme, the monitoring device 105 functions as the proxy server that relays communication between the image forming device 106 having a self-monitoring function and the server group. Because the image forming device 106 having the self-monitoring function has a function for linking with a cloud service, it is possible to provide more services to the image forming device 106 in the case of monitoring using the proxy scheme than in the case of monitoring using the polling scheme. The monitoring device 105 of the present example has a first mode in which devices are managed using only the polling scheme, and a second mode in which devices are managed using both the polling scheme and the proxy scheme.

The device management unit 503 performs a process of setting proxy server information held by the device management unit 503, a registration instruction process, or the like with respect to the image forming device 106 having the self-monitoring function. Moreover, the device management unit 503 registers the image forming device 106 for a device management service (e.g., the authentication and authorization server 102) in place of image forming devices 106 that do not have the self-monitoring function. The device management unit 503 includes a task setting unit 511, a determination unit 512, and a registration unit 513. The task setting unit 511 sets a task for registering a device with the device management service. In this device registration task, it is also possible to set device re-registration (e.g., from registration of the device as a device that does not have the self-monitoring function to re-registration of the device as a device having the self-monitoring function). The determination unit 512 determines whether or not to execute a process for re-registering the image forming device 106 for the device management service. The determination unit 512 determines whether or not it is a target of the re-registration process on the basis of whether or not the image forming device 106 has the self-monitoring function for the device management service. The registration unit 513 performs a device registration process for the device management service and a registration instruction process for the device on the basis of the device registration task and the instruction from the device detail screen. Moreover, when the device is registered as the device having the self-monitoring function, the registration unit 513 performs a proxy setting process using proxy information of the proxy server function for a device using the proxy server 501.

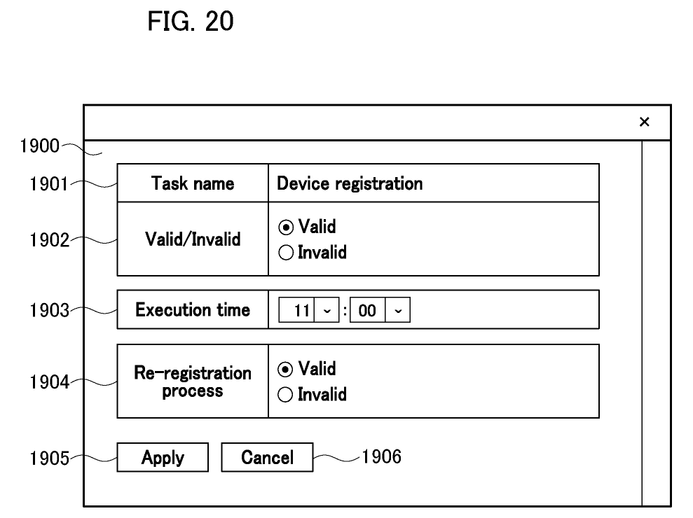

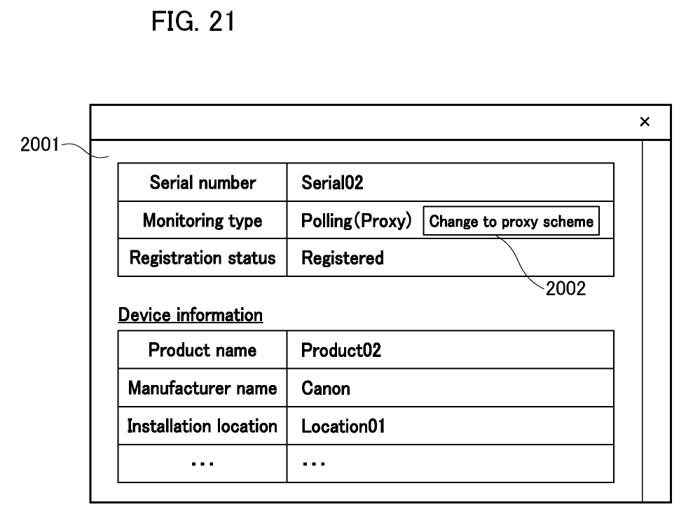

The task management unit 504 manages various types of tasks for the monitoring device 105, such as monitoring and registering the image forming device 106. The task management unit 504, for example, manages device registration tasks. The data transmission unit 505 transmits, to the resource server 103, monitoring data acquired from the image forming device 106 that does not have the self-monitoring function held by the data management unit 502 and the like. The display control unit 506 controls the display of screens provided by the monitoring device 105. In the present example, the display control unit 506 controls the display of a task setting screen (FIG. 20) and a device detail screen (FIG. 21), which will be described below.

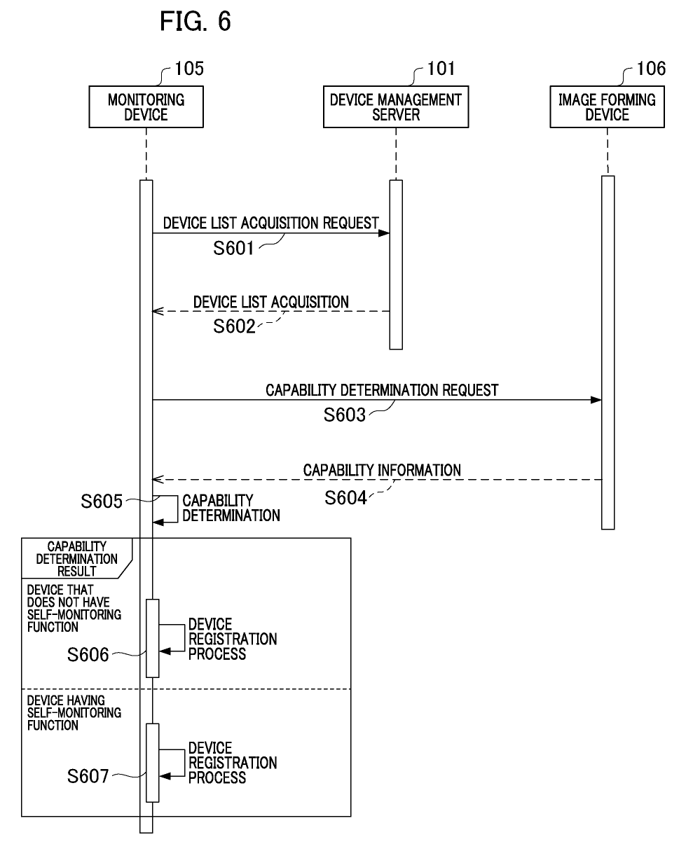

A process for registering the image forming device 106 with the device management service in the present example will be described using FIGS. 6 to 18. During the registration process, each process performed by the image forming device 106 is realized by the CPU 201 of the image forming device 106 executing a program stored in a memory (the ROM 202 or the HDD 205). Each process performed by the monitoring device 105 is realized by the CPU 303 of the monitoring device 105 executing a program stored in the memory 304. Each process performed by the device management server 101 is realized by the CPU 303 of the device management server 101 executing a program stored in the memory 304. Each process performed by the authentication and authorization server 102 is realized by the CPU 303 of the authentication and authorization server 102 executing a program stored in the memory 304.

In the present example, the registration process for the device management service and the monitoring mode of the monitoring device 105 differ according to whether or not the image forming device 106 has a self-management function. Therefore, in the registration process of the image forming device 106 for the device management service, the capability determination of whether or not the image forming device 106 has the self-management function is performed. FIG. 6 is a sequence diagram showing a capability determination process for the image forming device 106. Here, it is assumed that a device serving as a management target of the monitoring device 105 is managed by the device management server 101 in advance.

In S601, the device management unit 503 of the monitoring device 105 requests the device management server 101 to acquire a management target device list of the monitoring device 105. The device management server 101 has a managed device target list in which devices serving as management targets of the monitoring device 105 are listed in advance. In S602, the device management server 101 transmits the management target device list of the monitoring device 105 to the monitoring device 105 in response to the management target device list acquisition request. Thereby, the device management unit 503 of the monitoring device 105 acquires the management target device list of the monitoring device 105 from the device management server 101.

In S603, the device management unit 503 of the monitoring device 105 makes a device capability determination request with respect to a device in the management target device list. In the present example, the device management unit 503 of the monitoring device 105 makes a request for determining the capability of the image forming device 106 with respect to the communication unit 401 of the image forming device 106. In the capability determination, it is determined whether or not the image forming device 106 has the self-monitoring function and whether or not monitoring target data can be acquired when it does not have the self-monitoring function.

In S604, the data management unit 402 of the image forming device 106 transmits information for use in the device capability determination to the device management unit 503 of the monitoring device 105 via the communication unit 401. Examples of information for use in the device capability determination include the presence or absence of predetermined services or modules, firmware version information, and the like. In S605, the determination unit 512 of the monitoring device 105 performs the device capability determination on the basis of the information acquired from the device. The determination unit 512 first determines whether or not the image forming device 106 has a self-monitoring function. For example, the determination unit 512 determines whether or not the image forming device 106 is a device having the self-monitoring function on the basis of whether or not there is a service having the self-monitoring function. In this case, when there is a service having the self-monitoring function, the determination unit 512 determines that the device is the device having the self-monitoring function. Also, when the image forming device 106 does not have the self-monitoring function, the determination unit 512 determines whether or not the device is a device capable of being monitored by the monitoring device 105. For example, the determination unit 512 determines whether or not the device can be monitored according to whether or not the device can collect monitoring target data and transmit the collected monitoring target data to the monitoring device 105. In addition, a device capability determination method is not limited to this, and other methods may be performed. In addition, it may be determined whether or not a self-monitoring function is provided on a device side and a response of a determination result may be transmitted to the monitoring device 105.

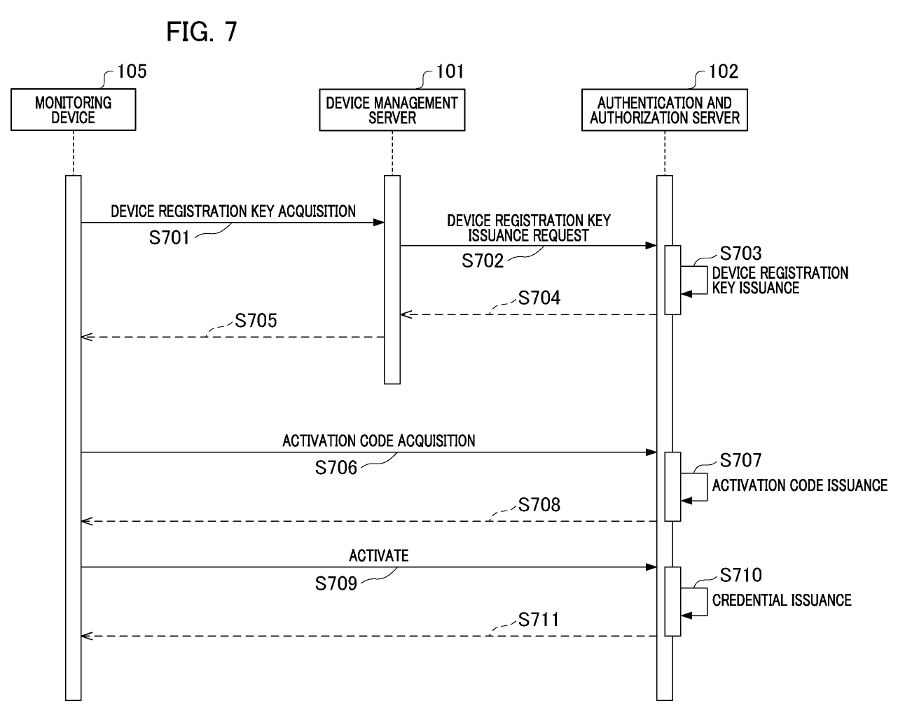

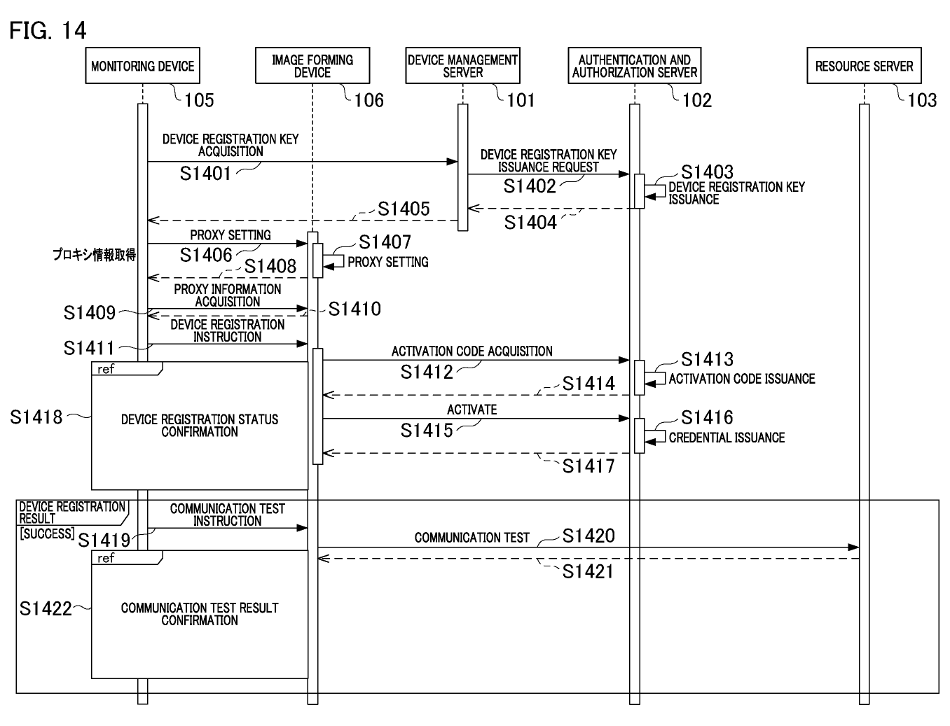

The monitoring device 105 issues a registration processing instruction according to the determination result. In the case of the device having the self-monitoring function, the monitoring device 105 executes a process for registering a device having the self-monitoring function in S607. Details of the process for registering the device having the self-monitoring function will be described below using FIG. 14. In the case of a device that does not have the self-monitoring function but can be monitored, the monitoring device 105 executes a process for registering a device that does not have the self-monitoring function in S606. Details of the process for registering the device that does not have the self-monitoring function will be described below using FIG. 7. In addition, in the case of the device that does not have the self-monitoring function and cannot be monitored, the device is not registered with the monitoring device 105, and this process ends.

Next, a registration processing for an image forming device that does not have the self-monitoring function in S606 will be described using FIG. 7. FIG. 7 is a sequence diagram showing a process for registering an image forming device that does not have the self-monitoring function. In the present example, a device registration key is used to register the image forming device 106 that is the management target with the authentication and authorization server 102. The device registration key is information required when the image forming device 106 that is the management target is registered with the authentication and authorization server 102 of the device management service.

In S701, the device management unit 503 of the monitoring device 105 requests the device management server 101 to acquire the device registration key. The device registration key acquisition request includes the device identification information of the registration target device and the token of the monitoring device 105. In the present example, as the device identification information, information for uniquely identifying the image forming device 106 by the device management server 101 (hereinafter referred to as a device management service device ID) is assigned to a device registration key acquisition request. The device management service device ID is managed as a part of the device management information in the data management unit 502.

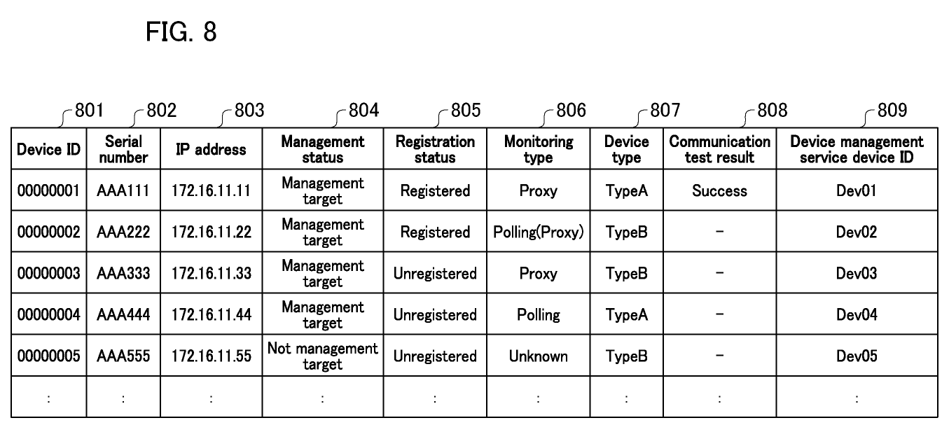

Here, an example of device management information managed by the data management unit 502 of the monitoring device 105 will be described using FIG. 8. FIG. 8 is a diagram showing an example of a device management information table. The device management information includes, for example, a device ID 801, a serial number 802, an IP address 803, a management status 804, a registration status 805, a monitoring type 806, a device type 807, a communication test result 808, and a device management service device ID 809.

The device ID 801 is information for uniquely identifying a device within the system. The serial number 802 is information for uniquely identifying the device when the device is shipped. The IP address 803 is information indicating an IP address of the device. The management status 804 is information indicating whether or not the device serves as a management target of the device management system. Here, the image forming device 106 included in the management target device list acquired from the device management server 101 in step S602 is determined to be a management target. The registration status 805 is information indicating whether or not the image forming device 106 serving as the management target has been registered with the device management service.

The monitoring type 806 is information indicating a type of monitoring to be performed. For example, the image forming device 106 having the self-monitoring function performs monitoring via the proxy of the monitoring device 105. Therefore, “Proxy” is stored in the monitoring type 806 for the image forming device 106 having the self-monitoring function. The image forming device 106 that does not have the self-monitoring function performs a monitoring process by collecting monitoring data from the monitoring device 105 through periodic polling. Therefore, “Polling” is stored in the monitoring type 806 for the image forming device 106 that does not have the self-monitoring function. Moreover, in the image forming device 106 having the self-monitoring function of currently performing monitoring through periodic polling, when it is possible to switch the monitoring to monitoring via the proxy, switching information indicating this (e.g., “Polling (Proxy)”) is stored in the monitoring type 806. Also, in the case of a device that does not have monitorable capability information or for which capability determination is not performed, information indicating this (e.g., “Unknown”) is stored in the monitoring type 806.

The device type 807 is information indicating the type of device controller or platform. For example, a predetermined type (e.g., Type A, Type B, or the like) is stored in the device type 807. The communication test result 808 is information indicating whether or not a communication test for each cloud service has succeeded in the device that performs proxy monitoring. When the communication test has succeeded, information indicating the success of the communication test is stored in the communication test result 808. The device management service device ID 809 is information with which the device management server 101 uniquely identifies the image forming device 106. In addition, device management information is not limited to this and may include other information.

The description returns to FIG. 7. In S702, the device management server 101 verifies the token of the monitoring device 105 included in the received device registration key acquisition request and the device identification information of the registration target device, and then requests the authentication and authorization server 102 to issue a device registration key. The device registration key issuance request includes the device management service device ID. Specifically, the device management server 101 first verifies the token of the monitoring device 105 included in the device registration key acquisition request. After the token is verified, the device management server 101 confirms whether or not the image forming device 106 is a device managed on the device management server 101 on the basis of the device management service device ID.

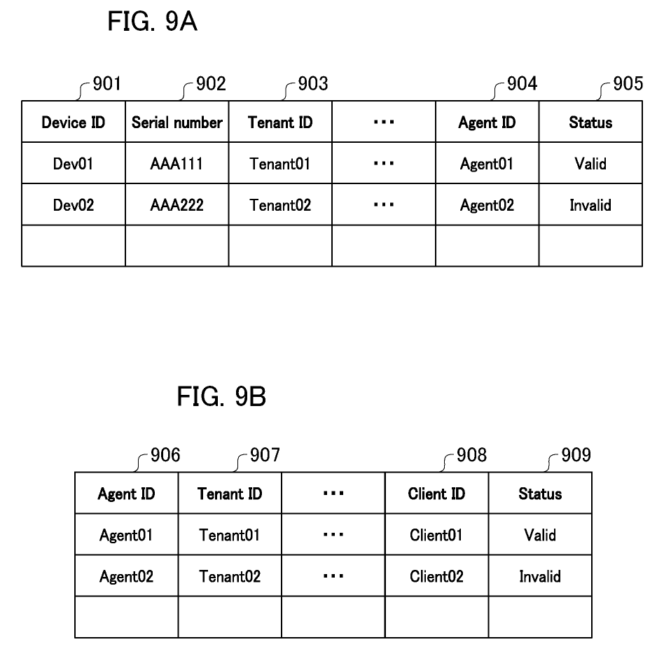

Here, the information managed by the device management server 101 will be described using FIGS. 9A and 9B. FIG. 9A is a diagram showing an example of a device management table managed by the device management server 101. In the device management table, information about a device serving as a service target provided by the device management server 101 is managed. The device management table includes, for example, a device ID 901, a serial number 902, a tenant ID 903, an agent ID 904, and a status 905.

The device ID 901 is a device management service device ID. The device ID 901 is the same information as the client ID in the client management table managed by the authentication and authorization server 102, which will be described below. The serial number 902 is information for uniquely identifying the device. The tenant ID 903 is information for identifying the tenant to which the device belongs. The agent ID 904 is information for identifying an agent to which the device is linked. The status 905 is information indicating a valid/invalid status of the device.

FIG. 9B is a diagram showing an example of an agent management table managed by the device management server 101. In the agent management table, information about an agent that has contracted for a service provided by the device management server 101 is managed. The agent management table includes, for example, an agent ID 906, a tenant ID 907, a client ID 908, and a status 909.

The agent ID 906 is information for uniquely identifying the monitoring device 105 by the device management server 101. The tenant ID 907 is information for identifying the tenant to which the agent belongs. The client ID 908 is the client ID in the client management table managed by the authentication and authorization server 102. The status 909 is information indicating the valid/invalid status of the agent.

A timing at which information is registered in the device management table or agent management table of the device management server 101, for example, is a timing at which the service providing server 104 specifies a service provision target device. A method for specifying the target device, for example, may be performed from a web UI provided in the service providing server 104 or may use a web API.

The description returns to FIG. 7. The device management server 101 confirms that the device corresponding to the device management service device ID is managed in the device management table, and then requests the authentication and authorization server 102 to issue a device registration key (S702). In S703, the authentication and authorization server 102 confirms whether the registration target device is being managed on the authentication and authorization server 102, and issues the device registration key. The authentication and authorization server 102 first confirms whether the device is being managed in the client management table on the basis of the device management service ID included in the device registration key issuance request.

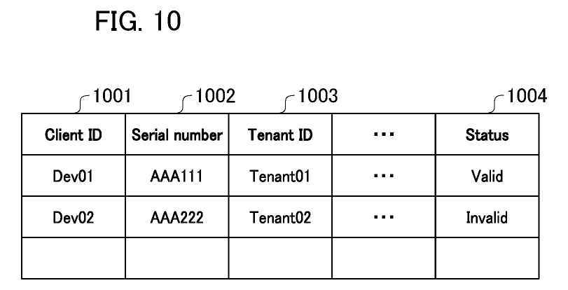

Here, information managed by the authentication and authorization server 102 will be described. FIG. 10 is a diagram showing an example of a client management table managed by the authentication and authorization server 102. The client management table includes, for example, a client ID 1001, a serial number 1002, a tenant ID 1003, and a status 1004. The client ID 1001 is information with which the authentication and authorization server 102 uniquely identifies a device. The client ID 1001 is the same information as the device ID managed by the device management server 101 in the device management table and is information different from the client ID 908 managed by the device management server 101 in the agent management table. The serial number 1002 is information with which the device is uniquely identified. The tenant ID 1003 is information for identifying the tenant to which the device belongs. The status 1004 is information indicating the valid/invalid status of the client.

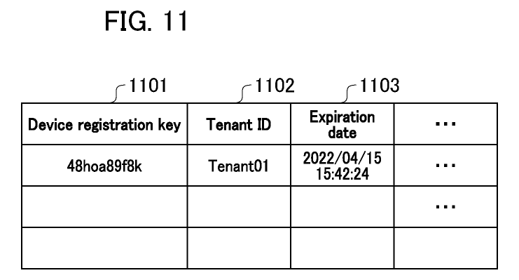

The authentication and authorization server 102 confirms that the device is managed in the client management table on the basis of the device management service ID included in the device registration key issuance request, and then issues a device registration key. Also, the authentication and authorization server 102 stores the issued device registration key in the device registration key management table. Here, the device registration key management table for managing the issued device registration key will be described. FIG. 11 is a diagram showing an example of the device registration key management table managed by the authentication and authorization server 102. The device registration key management table includes, for example, a device registration key 1101, a tenant ID 1102, and an expiration date 1103.

The device registration key 1101 is information for uniquely identifying the device registration key. The tenant ID 1102 is information for uniquely identifying the tenant, and a device registration key is issued for each tenant. It is also possible to issue a plurality of device registration keys in the same tenant, and if a tenant has a plurality of devices, a device registration key can be issued for each device. The expiration date 1103 is information indicating the expiration date of the device registration key.

The description returns to FIG. 7. The device registration key issued in S703 is transmitted to the monitoring device 105, which is a device registration key acquisition request source, via the device management server 101. In S704, the authentication and authorization server 102 transmits the device registration key issued in S703 to the device management server 101. In S705, the device management server 101 transmits the device registration key received from the authentication and authorization server 102 to the monitoring device 105.

In S706, the device management unit 503 of the monitoring device 105 requests the authentication and authorization server 102 to acquire an activation code. The activation code acquisition request includes an acquired device registration key and a device serial number. In S707, the authentication and authorization server 102 issues an activation code in accordance with the activation code acquisition request. The authentication and authorization server 102 first confirms the validity of the device registration key using the client management table and the device registration key management table on the basis of the serial number and device registration key included in the activation code acquisition request. When the device registration key is valid, the authentication and authorization server 102 issues the activation code and stores the activation code in the activation code management table.

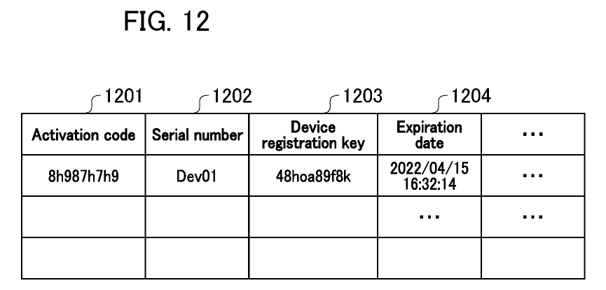

Here, the activation code management table for managing activation codes will be described. FIG. 12 shows an example of the activation code management table managed by the authentication and authorization server 102. The activation code management table includes, for example, an activation code 1201, a serial number 1202, a device registration key 1203, and an expiration date 1204. The activation code 1201 is a code issued for each device required to activate a client. The serial number 1202 is information for uniquely identifying the device. The device registration key 1203 is information for uniquely identifying the device registration key. The expiration date 1204 is information indicating the expiration date of the activation code.

The description returns to FIG. 7. In S708, the authentication and authorization server 102 transmits the activation code issued in S707 to the monitoring device 105, which is an activation code acquisition request source. In S709, the device management unit 503 of the monitoring device 105 transmits an activation request to the authentication and authorization server 102. The activation request includes a device registration key, an activation code, and a device serial number.

In S710, the authentication and authorization server 102 issues a credential in response to the activation request. The authentication and authorization server 102 first confirms the validity of the activation code. The authentication and authorization server 102 confirms the validity of the activation code on the basis of the serial number, the device registration key, and the activation code included in the activation request, the client management table and the activation code management table. Also, when the activation code is confirmed to be valid, the authentication and authorization server 102 issues the credential and stores the credential in the credential management table. Also, the authentication and authorization server 102 storing the credential validly updates and stores the status information managed in the client management table.

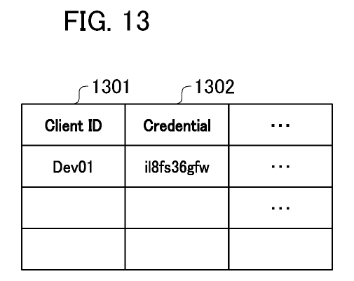

Here, the credential management table for managing credentials will be described. FIG. 13 is a diagram showing an example of a credential management table managed by the authentication and authorization server 102. The credential management table includes, for example, a client ID 1301 and a credential 1302. The client ID 1301 is information for uniquely identifying a client (device). The client ID 1301 is the same information as the client ID 1001 and the device ID 901 managed by the device management server 101, and is information different from the client ID 908 managed by the device management server 101 in the agent management table. The credentials 1302 are private key information required when a token is acquired.

The description returns to FIG. 7. In S711, the authentication and authorization server 102 transmits the credential issued in S710 to the monitoring device 105, which is an activation request source. Thereby, the client of the image forming device 106, which is a registration target device, becomes valid and the monitoring device 105 can collect monitoring data of the image forming device 106 and transmit the monitoring data to the resource server 103.

Next, a process for registering an image forming device having the self-monitoring function will be described. FIG. 14 is a sequence diagram showing an example of the process for registering the image forming device having the self-monitoring function. In S1401, the device management unit 503 of the monitoring device 105 requests the device management server 101 to acquire a device registration key. The device registration key acquisition request includes device identification information of the image forming device 106 that is a registration target. The device identification information is a device management service device ID included in a list of management target devices. The device management service device ID is managed in the data management unit 502 as a part of the device management information. The device registration key is information required when the image forming device 106 is registered with the authentication and authorization server 102 of the device management service.

In S1402, the device management server 101 verifies the token of the monitoring device 105 included in a received device registration key acquisition request and the device identification information of the registration target device, and then requests the authentication and authorization server 102 to issue the device registration key. The device registration key issuance request includes a device management service device ID. Specifically, the device management server 101 first verifies the token of the monitoring device 105 included in the device registration key acquisition request. After the token is verified, the device management server 101 confirms whether the image forming device 106 is a device managed on the device management server 101 on the basis of the device management service device ID. After it is confirmed that the image forming device 106 is managed in the device management table, the device management server 101 requests the authentication and authorization server 102 to issue a device registration key.

In S1403, the authentication and authorization server 102 confirms whether or not the image forming device 106 is being managed on the authentication and authorization server 102, and issues a device registration key. The authentication and authorization server 102 first confirms whether the image forming device 106 is being managed in the client management table, on the basis of the device management service ID included in the device registration key issuance request. After it is confirmed that the image forming device 106 is being managed in the client management table, the authentication and authorization server 102 issues the device registration key.

The device registration key issued in S1403 is transmitted to the monitoring device 105, which is a device registration key acquisition request source, via the device management server 101. In S1404, the authentication and authorization server 102 transmits the device registration key issued in S1403 to the device management server 101. In S1405, the device management server 101 transmits the device registration key received from the authentication and authorization server 102 to the monitoring device 105.

In S1406, the registration unit 513 of the device management unit 503 of the monitoring device 105 transmits proxy information of the proxy server 501 provided in the monitoring device 105 to the authentication unit 403 of the image forming device 106. The proxy information is access information for the proxy function of causing the image forming device 106 to use the proxy server 501. In S1407, the data management unit 402 of the image forming device 106 sets and stores the proxy information of the proxy server 501 acquired in S1404. In S1408, the image forming device 106 transmits a notification of proxy information setting completion to the monitoring device 105.

In S1408, the device management unit 503 of the monitoring device 105 requests the authentication unit 403 of the image forming device 106 to acquire the proxy information set in S1407. In S1409, the image forming device 106 transmits the requested proxy information to the monitoring device 105. Also, the monitoring device 105, having newly acquired the proxy information set in S1407 from the image forming device 106, stores the acquired proxy information in the data management unit 502. Although an example in which the proxy setting is performed after the device registration key is acquired has been described in the present example, this order is not important. The proxy setting (S1406 to S1410) may be performed first and the device registration key acquisition process (S1401 to S1405) may be performed subsequently.

In S1411, the device management unit 503 of the monitoring device 105 issues a device registration instruction to the authentication unit 403 of the image forming device 106. The device registration instruction includes the device registration key acquired in S1401. In S1412, the authentication unit 403 of the image forming device 106 requests the authentication and authorization server 102 to acquire an activation code. The activation code acquisition request includes the device registration key acquired in S1411 and the serial number of the image forming device 106.

In S1413, the authentication and authorization server 102 issues an activation code in accordance with the activation code acquisition request. The authentication and authorization server 102 first confirms the validity of the device registration key using the client management table and the device registration key management table, on the basis of the serial number and the device registration key included in the activation code acquisition request. When the device registration key is valid, the authentication and authorization server 102 issues the activation code and stores the activation code in the activation code management table.

In S1414, the authentication and authorization server 102 transmits the activation code issued in S707 to the image forming device 106 that is an activation code acquisition request source in S708. In S709, the authentication unit 403 of the image forming device 106 transmits an activation request to the authentication and authorization server 102. The activation request includes a device registration key, an activation code, and a serial number of the image forming device 106.

In S1416, the authentication and authorization server 102 issues a credential in response to the activation request. The authentication and authorization server 102 first confirms the validity of the activation code. The authentication and authorization server 102 confirms the validity of the activation code on the basis of the serial number, the device registration key, and the activation code included in the activation request, the client management table, and activation code management table. Also, when the activation code is confirmed to be valid, the authentication and authorization server 102 issues a credential and stores the credential in the credential management table. Also, after saving the credential, the authentication and authorization server 102 validly updates and stores the status information managed in the client management table. In S1417, the authentication and authorization server 102 transmits the credential issued in S710 to the image forming device 106, which is the activation request source.

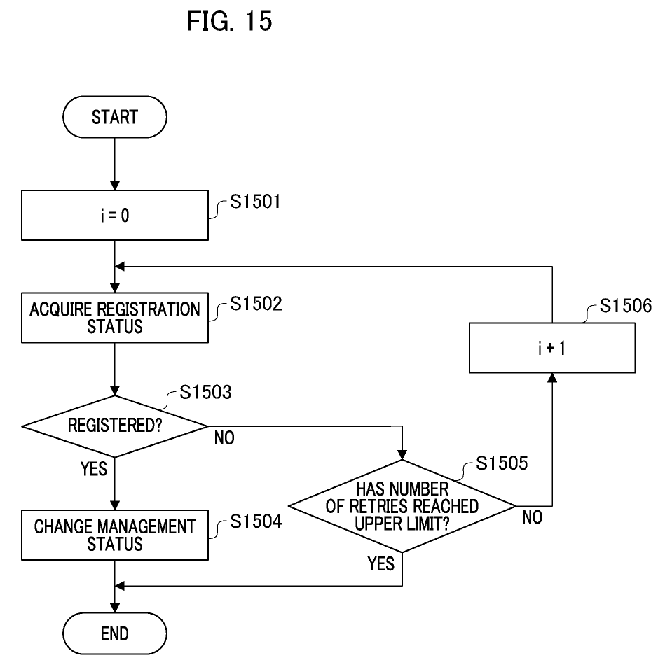

The monitoring device 105, having issued the device registration instruction in S1411, subsequently performs a device registration status confirmation process in S1418. In S1418, the device management unit 503 of the monitoring device 105 confirms a device registration status with respect to the authentication unit 403 of the image forming device 106. A device registration status confirmation process will be described using FIG. 15.

FIG. 15 is a flowchart showing the device registration status confirmation process in the monitoring device 105. In S1501, the device management unit 503 of the monitoring device 105 initializes the count of the number of times the device registration status has been acquired. Specifically, the device management unit 503 initializes variable i to 0. Variable i is a value used to count the number of times the device registration status has been acquired.

In S1502, the device management unit 503 of the monitoring device 105 requests the authentication unit 403 of the image forming device 106 to acquire the device registration status from the device management service, and acquires the device registration status as a response. In S1503, the device management unit 503 of the monitoring device 105 confirms whether the device registration status acquired in S1502 indicates that the device has been registered. When the device has been registered, the device management unit 503 performs the processing of S1504. On the other hand, when the device has not been registered, the device management unit 503 performs the processing of S1505.

In S1504, the device management unit 503 of the monitoring device 105 changes the value of the registration status 805 in the device management information table managed by the data management unit 502 to “registered.” In S1505, the device management unit 503 of the monitoring device 105 confirms whether the number of times the device registration status has been acquired has reached an upper limit. Specifically, when variable i is smaller than a threshold N, the device management unit 503 determines that the upper limit has not been reached. The threshold N is a predetermined value for the upper limit (the number of retries) for acquiring the device registration status. When variable i is equal to the threshold N, it is determined that the upper limit has been reached, and the present process ends. On the other hand, when variable i is smaller than the threshold N, it is determined that the upper limit has not been reached, and the device management unit 503 performs the processing of S1506. In S1506, the device management unit 503 of the monitoring device 105 increments the value of variable i by 1 and returns the process to S1502.

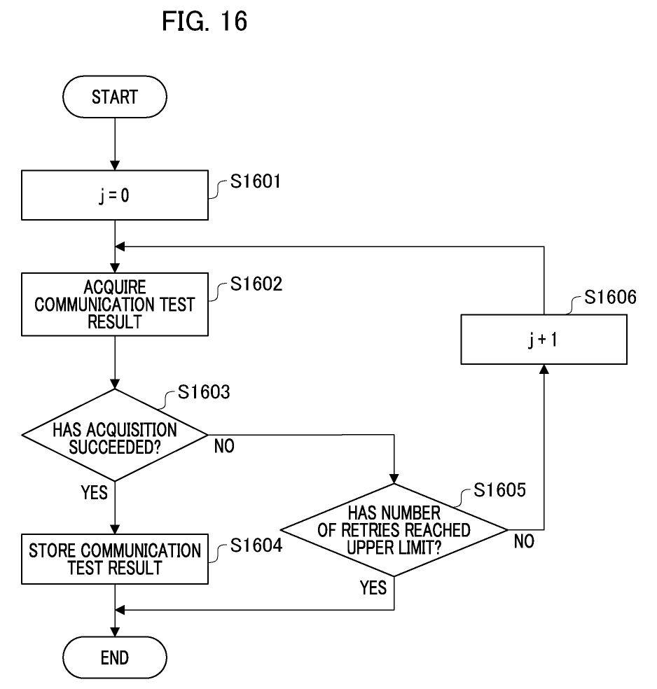

The description returns to FIG. 14. When device registration has succeeded, a communication test process from S1419 to S1423 is performed. In S1419, the device management unit 503 of the monitoring device 105 issues a communication test instruction to the authentication unit 403 of the image forming device 106. The image forming device 106, having received the communication test instruction, performs a communication test on the server to be used in S1420. For example, when the server to be used is the resource server 103, the monitoring unit 404 of the image forming device 106 performs a communication test on the resource server 103. In S1421, the monitoring unit 404 of the image forming device 106 receives a response to the communication test from the resource server 103. In S1422, the device management unit 503 of the monitoring device 105 confirms a communication test result with respect to the authentication unit 403 of the image forming device 106. Details of a communication test result confirmation process will be described using FIG. 16.

FIG. 16 is a flowchart showing the communication test result confirmation process in the monitoring device 105. In S1601, the device management unit 503 of the monitoring device 105 initializes variable j to 0. Variable j is a value used to count the number of times a communication test result has been acquired. In S1602, the device management unit 503 of the monitoring device 105 acquires the communication test result from the authentication unit 403 of the image forming device 106.

In S1603, the device management unit 503 of the monitoring device 105 confirms whether or not the communication test result has been successfully acquired in S1602. When the communication test result has been successfully acquired, the process proceeds to S1604. When the communication test result has not been successfully acquired, the process proceeds to S1605. In S1604, when the communication test has succeeded, the device management unit 503 of the monitoring device 105 changes the communication test result in the device management information table managed by the data management unit 502 to “success.”

In S1605, the device management unit 503 of the monitoring device 105 confirms whether the number of times the communication test result has been acquired has reached its upper limit. Specifically, when variable j is smaller than a threshold M, the device management unit 503 determines that the upper limit has not been reached. The threshold M is a predetermined value for the upper limit (number of retries) for acquiring the communication test result. When variable j is equal to the threshold M, it is determined that the upper limit has been reached and the present process ends. On the other hand, when variable j is smaller than the threshold M, it is determined that the upper limit has not been reached, and the device management unit 503 performs the processing of S1606. In S1606, the device management unit 503 of the monitoring device 105 increments the value of variable j by 1 and returns the process to S1602.

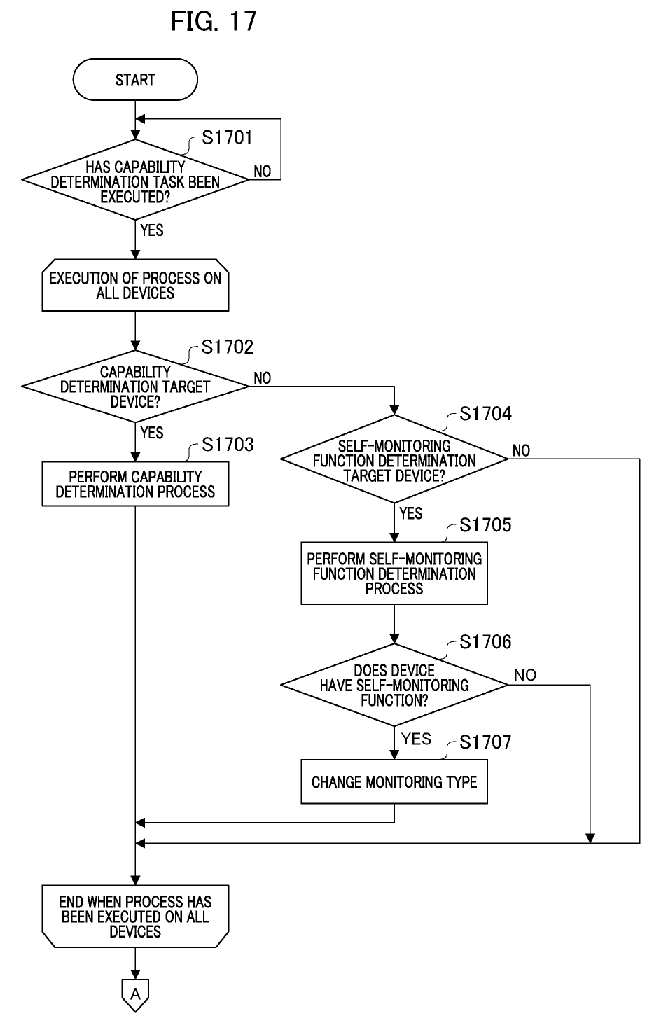

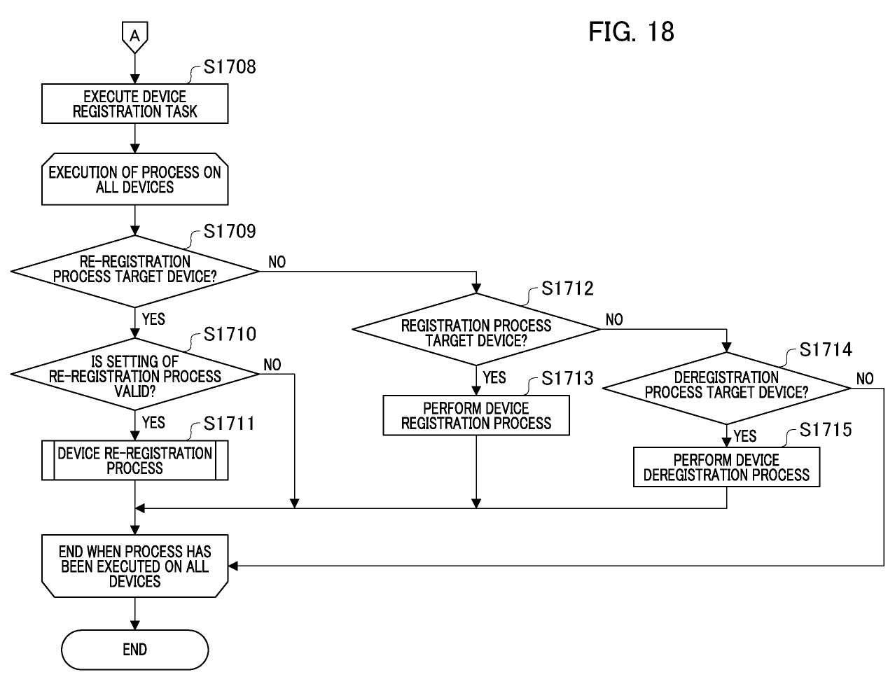

Next, the re-registration determination process for the image forming device 106 will be described. FIGS. 17 and 18 are flowcharts showing the re-registration determination process for the image forming device in example 1. In the re-registration determination process, it is determined whether a device registered as a device that does not have the self-monitoring function should be re-registered as a device having the self-monitoring function. A device that does not have the self-monitoring function can become a device having the self-monitoring function corresponding to the device management service by updating its firmware or the like. Each process to be executed by the monitoring device 105 in the re-registration determination process is realized by the CPU 303 of the monitoring device 105 executing a program stored in the memory 304.

In S1701, the task management unit 504 checks whether or not the timing is a timing to execute a capability determination task of determining the capability of a device managed by the monitoring device 105. If the timing is a timing to execute the capability determination process, the task management unit 504 performs the processing of S1702. On the other hand, if the timing is not a timing to execute the capability determination process, the task management unit 504 returns the process to S1701.

In S1702 to S1707, the monitoring device 105 executes the capability determination task for each of all devices managed within the monitoring device 105. The capability determination task is completed if the capability determination process for all devices is completed. The task management unit 504 selects one device from all devices managed by the monitoring device 105 and iterates the processing of S1702 to S1707 until the process is completed for all devices managed within the monitoring device 105.

First, in S1702, the task management unit 504 determines whether the selected device is an execution target device of the capability determination process. The task management unit 504 determines whether the device is an execution target device of the capability determination process on the basis of device management information held by the data management unit 502. Specifically, when the monitoring type 806 in the device management information table (FIG. 8) is “Unknown,” the task management unit 504 determines that the device is an execution target device of the capability determination process, and performs the processing of S1703. On the other hand, when the monitoring type 806 is “Proxy,” “Polling,” or “Polling (Proxy),” the task management unit 504 determines that the device is not an execution target device of the capability determination process, and performs the processing of S1704.

In S1703, the monitoring device 105 performs the device capability determination process. In this capability determination process, the monitoring device 105 determines the device capability on the basis of, for example, information about whether or not the device is a management target and information about whether or not the device has the self-monitoring function. The monitoring device 105 determines whether or not the device is a management target on the basis of the management status 804 in the device management information table. Also, when the management status 804 is a management target, the monitoring device 105, for example, acquires information about whether or not there is a service having the self-monitoring function as information about whether or not the device has the self-monitoring function. Moreover, information about whether a self-monitoring module corresponding to the self-monitoring unit 406 is installed in the device may be acquired. When there is a service having a self-monitoring function, the device is determined to have the self-monitoring function. On the other hand, when there is no service having the self-monitoring function, the device is determined not to have the self-monitoring function.

In S1704, the task management unit 504 determines whether the selected device is an execution target device of the self-monitoring function determination process on the basis of the device management information held by the data management unit 502. The self-monitoring function determination process is a process for determining whether the device having the self-monitoring function has been firmware-updated with respect to the image forming device 106 that is being monitored by collecting monitoring data through periodic polling in a state in which it has already been registered with the authentication and authorization server 102. Therefore, the target device of the self-monitoring function determination process is a management target and becomes a device that has been registered and is being monitored through polling. The task management unit 504 determines whether the device is a target of a self-monitoring function determination process on the basis of the management status 804, the registration status 805, and the monitoring type 806 in the device management information table. When it is determined that the device is the target of the self-monitoring function determination process, the task management unit 504 performs the processing of S1705. On the other hand, when it is determined that the device is not a target of the self-monitoring function determination process, the task management unit 504 ends a process of the capability determination task and performs the processing of S1708.

In S1705, the determination unit 512 of the device management unit 503 performs the self-monitoring function determination process. In this self-monitoring function determination process, the device management unit 503 determines whether the target device has the self-monitoring function. The determination of whether or not the device has the self-monitoring function, for example, is performed by determining whether or not a predetermined service having the self-monitoring function is present in the device. Moreover, the device may determine whether the device has the self-monitoring function by confirming whether the device has been upgraded to a predetermined firmware version. Moreover, it may be determined whether the device has the self-monitoring function by confirming information about whether a self-monitoring module corresponding to the self-monitoring unit 406 has been installed in the device.

In S1706, the determination unit 512 of the device management unit 503 determines a result of the self-monitoring function determination process in S1705. When it is determined that the device has the self-monitoring function, the device management unit 503 performs the processing of S1707. On the other hand, when it is determined that the device does not have the self-monitoring function, the device management unit 503 ends a process of the capability determination task and performs the processing of S1708. In S1707, the determination unit 512 of the device management unit 503 sets the monitoring type 806 in the device management information table managed by the data management unit 502 to “Polling (Proxy).” “Polling (Proxy)” is switching information indicating that the scheme can be switched from the polling scheme to the proxy scheme.

In S1708, the task management unit 504 begins the execution of the device registration task. In the processing of S1709 to S1714, the monitoring device 105 performs a process of the device registration task for each of all devices managed within the monitoring device 105. When the process has been completed for all devices, the device registration task is completed. The task management unit 504 selects one device from all devices managed within the monitoring device 105 and iterates the execution of the processing of steps S1709 to S1714 until the process is completed for all devices managed within the monitoring device 105.

In S1709, the task management unit 504 determines whether the selected device is the execution target device of the re-registration process on the basis of the device management information held by the data management unit 502. The re-registration process is a process for re-registering a device that is already being monitored by periodic polling so that it can be monitored via the proxy of the monitoring device 105. A device that is the target of the re-registration process is a device that has the self-monitoring function and whose monitoring data is collected by periodic polling without using the self-monitoring function. Therefore, the device that is the target of the re-registration process is the image forming device 106 for which the monitoring type 806 in the device management information table is “Polling (Proxy),” which indicates switching information. When the monitoring type 806 is “Polling (Proxy)” and it is determined that the device is to be re-registered, the task management unit 504 performs the processing of S1710. When the monitoring type 806 is not “Polling (Proxy)” and it is determined that the device is not to be re-registered, the task management unit 504 performs the processing of S1712.

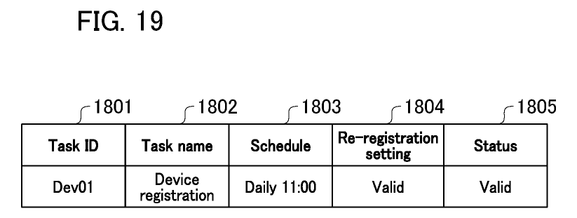

In S1710, the task management unit 504 determines whether or not the device re-registration process is valid on the basis of the device registration task management information stored in the data management unit 502. The validity/invalidity of the device re-registration process is information indicating whether or not to perform the device re-registration process and is assumed to be set in advance by the user. The user can set the validity/invalidity of the device re-registration process on the device registration task setting screen (FIG. 20), which will be described below. Information about the validity/invalidity of the re-registration process set by the user is managed by the device registration task management table (FIG. 19), which will be described below, stored in the data management unit 502. When it is determined that the device re-registration process is valid, the task management unit 504 performs the processing of S1711. On the other hand, when it is determined that the device re-registration process is invalid, the task management unit 504 ends the present process.

Here, the table for managing device registration task information will be described. FIG. 19 is a diagram showing an example of a device registration task management table. The device registration task management table is managed by the data management unit 502. The device registration task management table includes a task ID 1801, a task name 1802, a schedule 1803, a re-registration setting 1804, and a status 1805.

The task ID 1801 is information for uniquely identifying a task. The task name 1802 is information about a name of the task. The schedule 1803 is information indicating a task execution schedule. The re-registration setting 1804 is information indicating whether or not to execute the re-registration process in the device registration task. The re-registration setting 1804 stores a value of “valid” or “invalid” in accordance with the user’s selection on the device registration task setting screen. The status 1805 is information indicating whether the task is valid. In S1710, the task management unit 504 determines whether or not the device re-registration process is valid on the basis of the value of the re-registration setting 1804 in the device registration task management table.

FIG. 20 is a diagram showing an example of the device registration task setting screen. In the device registration task setting screen 1900, it is possible to set the registration process for a management target device registration process and set whether or not to perform a dynamic device re-registration process (switch a monitoring method) in this setting process. The device registration task setting screen 1900 displays a task name 1901, valid/invalid 1902, an execution time 1903, a re-registration process 1904, an apply button 1905, and a cancel button 1906. The task name 1901 displays a name of the task. The valid/invalid 1902 is a radio button for allowing the user to select whether or not to execute the task. The information of the status 1805 of the device registration task management table is set on the basis of the setting of the valid/invalid 1902. When “valid” is selected in the valid/invalid 1902, the information of the status 1805 is set to “valid.” When “invalid” is selected in the setting of the valid/invalid 1902, the information of the status 1805 is set to “invalid.” The execution time 1903 is an input block for setting the task execution schedule. The information of the schedule 1803 of the device registration task management table is set on the basis of the setting of the execution time 1903.

The re-registration process 1904 is a radio button for selecting whether or not to perform a re-registration process in the process executed by the device registration task. The information of the re-registration setting 1804 of the device registration task management table is set on the basis of the setting of the re-registration process 1904. In other words, in the re-registration process 1904, it is possible to set the dynamic switching of the monitoring method. When the user wants to set the dynamic switching of the monitoring method to “valid,” “valid” is selected in the re-registration process 1904. When the user wants to set the dynamic switching of the monitoring method to “invalid,” “invalid” is selected in the re-registration process 1904. The apply button 1905 is a button for storing the task settings. The cancel button 1906 is a button for canceling the task setting.

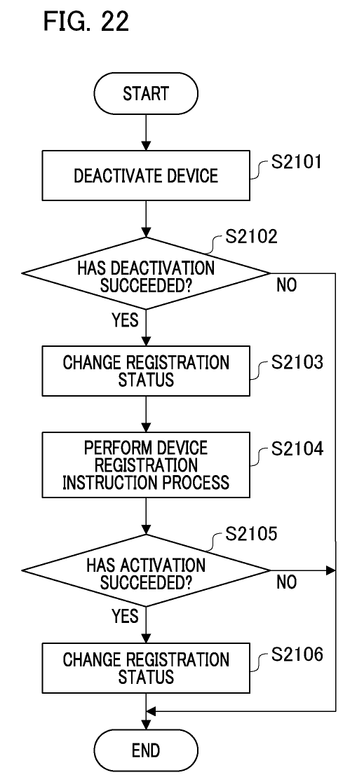

When it is detected that the apply button 1905 has been pressed, the task management unit 504 confirms whether the re-registration process has been set to “valid.” Also, when the re-registration process has been set to “valid,” the task management unit 504 determines whether or not a condition for validating the re-registration process has been satisfied. When the condition for validating the re-registration process is not satisfied, the task management unit 504 does not store the task setting. A condition for validating the re-registration process is that the network environment is one that can use a proxy scheme using the proxy server function of the monitoring device 105. To confirm that the network environment is one that can use the proxy scheme, it is confirmed whether a communication test has succeeded in one or more devices among devices managed using the proxy scheme, i.e., devices managed using the self-monitoring function. Therefore, a condition for validating the re-registration process is that a communication test has succeeded in one or more devices among the devices managed using the proxy scheme, i.e., the devices managed using the self-monitoring function. Specifically, the device management information table managed by the data management unit 502 has one or more devices for which the communication test result 808 is set to “success.” When a communication test is successful in one or more devices having the self-monitoring function that is a management target of the monitoring device 105 under the customer’s network environment, it can be confirmed that the customer’s network environment settings are those of a network environment capable of using the proxy scheme. When the customer’s network environment settings are those of a network environment capable of using the proxy scheme, it can be determined that the re-registration process for the other image forming devices 106 as devices having the self-monitoring function that use the proxy scheme will also be successful. When it is determined that the condition for validating the re-registration process is satisfied, the task management unit 504 stores the task with the set content. When it is determined that the condition for validating the re-registration process is not satisfied, the task management unit 504 may display a dialog screen to alert the user (warning). In this way, in the present example, when it is determined that the network environment is one that can use the proxy scheme, it is possible to set a task in which the re-registration process has been validly set. On the other hand, when it is determined that the network environment is not one that can use the proxy scheme, a task in which the re-registration process has been validly set is not set. The device re-registration process will be described below with reference to FIG. 22.

Here, the re-registration process for a single image forming device 106 can be manually performed from the device detail screen (FIG. 21), which displays detailed information for each device. FIG. 21 shows an example of the device detail screen. On the device detail screen 2001, detailed information about the device is displayed. The detailed information about the device includes a serial number that is information for uniquely identifying the device, a monitoring type, and a registration status. Furthermore, as the detailed information about the device, information such as a product name, a manufacturer name, and an installation location may be displayed. In the monitoring type attribute, information of the monitoring type 806 of the device management information table is displayed. Therefore, in the monitoring type attribute, any one of “Polling,” “Proxy,” “Polling (Proxy),” and “Unknown” is displayed.

When the value of the monitoring type attribute is “Polling (Proxy),” a change button 2002 appears next to it. The change button 2002 is a manual switching function of manually changing the monitoring method for the device from the polling scheme to the proxy scheme. For example, the button may display “change to proxy scheme.” If it is detected that the change button 2002 has been pressed, the task management unit 504 performs a device re-registration process and performs a process for changing the management method from the polling scheme to the proxy scheme. After the change button 2002 is pressed, the display of the monitoring type attribute changes from “Polling (Proxy)” to “Proxy,” such that it is possible to confirm that the device re-registration process has succeeded.

If it is detected that the change button 2002 has been pressed, the task management unit 504 performs a device re-registration process. Specifically, a process for deactivating the current registration of the device that does not have the self-monitoring function with respect to the device management service is first performed. In addition, when the deactivation process has failed, the monitoring device 105 continues monitoring the device using the polling scheme. When the deactivation process is successful, an instruction is issued to a device that is activated as a device having the self-monitoring function. After the device is activated as the device having the self-monitoring function, a communication test instruction is issued to the device. After the monitoring type attribute display is changed to “Proxy,” a button for issuing the communication test instruction or a button for changing to the polling scheme may be displayed next to the display.

The description returns to FIG. 18. When the device is a target of a re-registration process and the re-registration process is validly set, the task management unit 504 performs the processing of S1711. In S1711, the task management unit 504 performs a device re-registration process for re-registering the device having the self-monitoring function as the device having the self-monitoring function with the device management service. Details of the device re-registration process of S1711 will be described below using FIG. 22.

On the other hand, if the device is not the target of the re-registration process, the task management unit 504 performs the processing of S1712. In S1712, the task management unit 504 determines whether the selected device is an execution target device of the registration process on the basis of the device management information held by the data management unit 502. The registration process is a process for registering the image forming device 106 that is a management target, but is not registered with the authentication and authorization server 102. Therefore, the device serving as the target of the registration process is an image forming device 106 that is a management target but is not registered. The task management unit 504 determines whether or not the device is a target of the registration process, on the basis of the management status 804 and the registration status 805 in the device management information table. The task management unit 504 determines that the device is the target of the registration process when the management status 804 is “management target” and the registration status 805 is “unregistered.” When it is determined that the device is the target of the registration process, the task management unit 504 performs the processing of S1713. On the other hand, when it is determined that the device is not the target of the registration process, the task management unit 504 performs the processing of S1714. In S1713, the monitoring device 105 performs the device registration process. In the device registration process, the processing of S606 is performed when the device does not have the self-monitoring function and the processing of S607 is performed when the device has the self-monitoring function. Because the registration process in S1713 is not directly related to the present disclosure, a description thereof will be omitted.

In S1714, the task management unit 504 determines whether or not the selected device is an execution target device of a deregistration process on the basis of the device management information held by the data management unit 502. The deregistration process is a process for deregistering a device that is not the management target and is registered with the authentication and authorization server 102. Therefore, the device serving as the target of the deregistration process is a registered device that is not the management target. When the management status 804 in the device management information table is “not a management target” and the registration status 805 is “registered,” it is determined that the device is an execution target of the deregistration process and the task management unit 504 performs the processing of S1715. On the other hand, when the management status 804 is “not a management target” and the registration status 805 is not “registered,” the task management unit 504 determines that the device is not an execution target of the deregistration process, and ends the present process. In S1715, the task management unit 504 executes a device deregistration process. Because the deregistration process is not directly related to the present disclosure, a description thereof will be omitted.

Next, details of the device re-registration process in S1711 will be described using FIG. 22. FIG. 22 is a flowchart showing the re-registration process for the image forming device 106. The device serving as the target of the re-registration process of S1711 is a device that has a self-monitoring function, but collects monitoring data through periodic polling without using the self-monitoring function. A monitoring method using the proxy scheme in which the device management service is received using the proxy server function of the monitoring device 105 can provide more services to the device than that using the polling scheme. Therefore, the device having the self-monitoring function performs a process for deactivating the registration as the device that does not have the self-monitoring function and performs a process for registering the device as the device having the self-monitoring function so that the monitoring device 105 based on the proxy scheme can be used. In the present example, when a task in which the re-registration process is set to “valid” on the device registration task setting screen 1900 is created, the set task is stored only if the condition for validating the re-registration process is satisfied. Therefore, the customer’s network environment in which the re-registration process is executed is an environment in which a communication test has already succeeded in one or more devices among the devices managed using the self-monitoring function. Therefore, the customer’s network environment is not likely to be blocked by firewalls and the like, and can be determined to be compatible with the monitoring method based on the proxy scheme. Therefore, even if the device monitoring method is changed to the monitoring method based on the proxy scheme through the re-registration process, there is provided an environment in which the management of the device via the network can continue.

In S2101, the device management unit 503 performs a deactivation process for the target device. In the deactivation process, a deactivation request for the target device is transmitted to the authentication and authorization server 102. The deactivation request includes information of the device management service device ID 808 of the device serving as a target of the deactivation process. The authentication and authorization server 102, having received a request of the deactivation process from the monitoring device 105, changes the status 1004 of the target device managed in the client management table (FIG. 10) to an invalid status on the basis of the device management service device ID 808. Also, the authentication and authorization server 102 transmits the result of the deactivation process to the monitoring device 105, which is a deactivation request source.

In S2102, the device management unit 503 determines whether or not the deactivation of the target device has succeeded on the basis of a response from the authentication and authorization server 102 for the deactivation request. When the deactivation has succeeded, the monitoring device 105 performs the processing of S2103. On the other hand, when the deactivation has failed, the present process ends. In S2103, the device management unit 503 changes the registration status 805 of the device management information table (FIG. 8) held by the data management unit 502 from “registered” to “unregistered.”

In S2104, the registration unit 513 of the device management unit 503 performs the registration process for the target device as the device having the self-monitoring function. The registration process for the device having the self-monitoring function executed in S2104 is similar to the registration process for the image forming device having the self-monitoring function shown in FIG. 14. Through the present process, the monitoring device 105 sets proxy information of the proxy server 501 in the target device and allows the target device to use the proxy server 501 of the monitoring device 105 (S1406 to S1410). Moreover, the device registration instruction using the device registration key is issued to the target device (S1411), and the target device communicates with the authentication and authorization server 102 to register the device (S1412 to S1417).

In S2105, the device management unit 503 determines whether or not activation has succeeded. Whether or not the activation has succeeded is determined on the basis of a response to the activation request acquired from the authentication and authorization server 102 in S1417. When the activation has succeeded, the device management unit 503 performs the processing of S2106. On the other hand, when the activation has failed, the device management unit 503 ends the present process. In S2106, the device management unit 503 updates the device management information held by the data management unit 502. Specifically, the device management unit 503 changes the monitoring type 806, which is the device management information held by the data management unit 502, to “Proxy.” In addition, after the monitoring type 806 is changed to the proxy scheme, the communication test (S1419 to S1422) may be performed.

As described above, a device for which the monitoring method can be switched is identified by periodically checking the capability information of the device with respect to a motoring target device that does not have the self-monitoring function. Subsequently, when it is confirmed that a communication test has succeeded for one or more devices among devices managed using the self-monitoring function, a re-registration process is performed for all other devices for which the monitoring method can be switched. In other words, when the customer’s network environment is compatible with monitoring in the proxy scheme, the re-registration process for all devices for which the monitoring method can be switched can be executed. On the other hand, when the customer’s network environment is not compatible with monitoring in the proxy scheme due to a firewall or the like, a task of automatically switching the monitoring method cannot be set and a warning is displayed to the user. Thereby, it is possible to switch the monitoring method easily and securely and provide a relay device that improves the security of device registration for the device management service according to the self-monitoring function of the device.

### (Example 2)

In example 1, when it is confirmed that a communication test has succeeded in one or more devices among device managed using the self-monitoring function, the monitoring method can be dynamically switched with respect to other devices. However, because a service to be used differs according to a device type even among devices having the self-monitoring function, even if switching the monitoring method for a specific device is successful, switching the monitoring method for other devices may not necessarily be successful. In the present example, the device type is taken into consideration to realize more secure dynamic switching of the monitoring method. Hereinafter, only differences from example 1 will be described, and constituent elements and processing steps similar to those in example 1 are denoted by the same reference signs and descriptions thereof will be omitted.

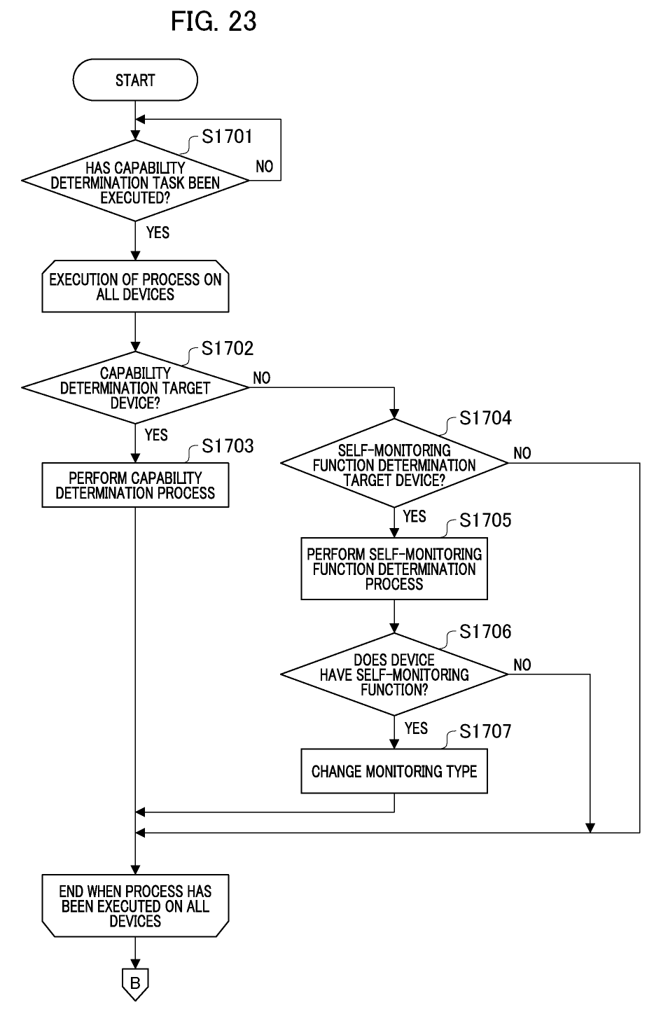

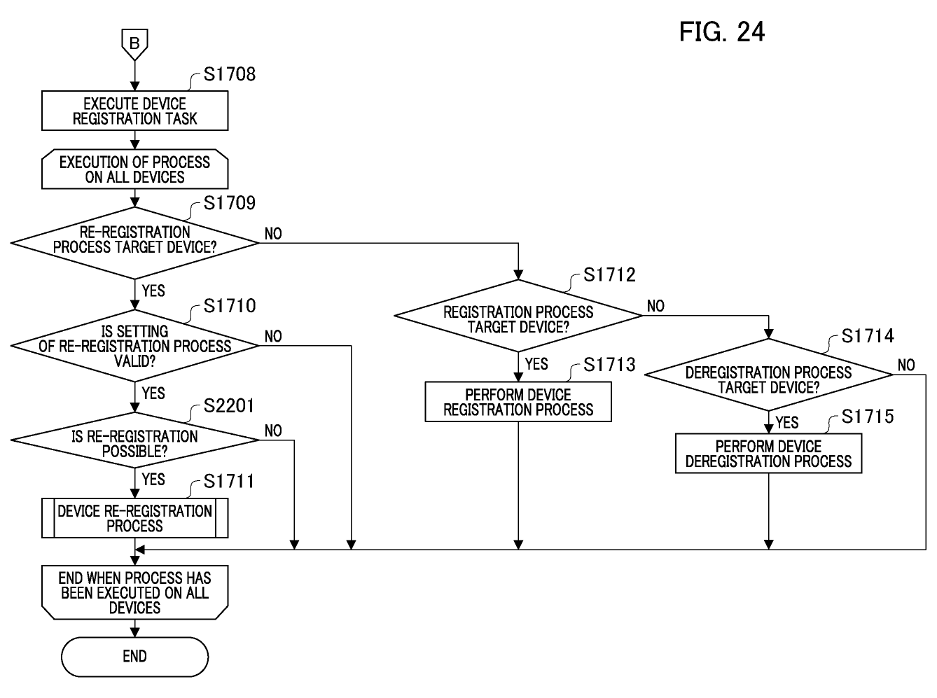

FIGS. 23 and 24 are flowcharts showing a re-registration determination process for the image forming device in example 2. Each process executed by the monitoring device 105 is realized by the CPU 303 of the monitoring device 105 executing a program stored in the memory 304. Processing steps identical to those in example 1 are denoted by reference signs similar to those of the re-registration determination process for an image forming device in example 1 (FIGS. 17 and 18), and descriptions thereof will be omitted.

In S1710, the task management unit 504 determines whether or not the device re-registration process is valid on the basis of the management information of the device registration task held by the data management unit 502. When it is determined that the device re-registration process is valid, the task management unit 504 performs the processing of S2201. On the other hand, if it is determined that the device re-registration process is invalid, the task management unit 504 ends the present process.

In S2201, the task management unit 504 determines whether or not the device can be re-registered. For example, it is determined whether or not the device can be re-registered on the basis of the device management information held by the data management unit 502. Specifically, it is determined whether the re-registration process for the processing target device is possible on the basis of the device type 807 of a device whose communication test result 808 is “success,” in accordance with the device type 807 of the device serving as a current processing target. When the device type 807 of the device whose communication test result 808 is “success” is the same as the device type 807 of the target device of the re-registration determination process, it is determined that the re-registration process for the device of the processing target is possible. Moreover, for example, it may be determined whether or not the device can be re-registered on the basis of a connection destination of a device whose communication test has already succeeded. When the connection destination of the target device of the re-registration determination process is included among connection destinations of devices whose communication tests have already succeeded, it can be determined that there is no possibility of blocking by a firewall or the like. Therefore, it is determined that the device can be re-registered. On the other hand, when a connection destination of a device of a current processing target is not included among the connection destinations of the devices whose communication tests have already succeeded, there is a possibility that the connection destination that is not included will be blocked by a firewall or the like. Therefore, it cannot be determined that the device can be re-registered. When it is determined that the device can be re-registered, the task management unit 504 performs the processing of S1711. On the other hand, when it is determined that the device cannot be re-registered, the task management unit 504 ends the present process. Moreover, when it is determined that the device cannot be re-registered, a dialog screen may be displayed to alert the user (a warning display) that the monitoring method could not be switched.

Moreover, even though the task is set to perform the re-registration process, the re-registration process is not performed on some devices, which will cause confusion for users. Therefore, even if the task shown in FIG. 20 is set, a determination process similar to S2201 may be performed. If the re-registration process is not performed on some devices, a dialog screen can be displayed to raise an alert (a warning display). By performing the processing of S2201, it is possible to select devices that can dynamically switch the monitoring method by determining whether or not the device can be re-registered in accordance with a type of device whose communication test has already succeeded and a connection destination thereof.

As described above, it is possible to switch the monitoring method more securely by selecting a device that dynamically switches the monitoring method in accordance with a type of device whose communication test has already succeeded and a connection destination thereof.

### (Example 3)

In the above-described examples, a method for switching the monitoring method more securely in consideration of the settings of the customer’s network environment has been described. However, a situation in which the connection to the cloud service may not be possible during the device registration process when the monitoring method is switched due to a temporary network problem or the like even if the customer’s network environment is set correctly is also considered. In this case, the device registration may not be possible and monitoring may stop. In the present example, such cases are taken into account and monitoring is continued as much as possible. Hereinafter, only differences from example 1 will be described, and constituent elements and processing steps similar to those in example 1 are denoted by the same reference signs and descriptions thereof will be omitted.

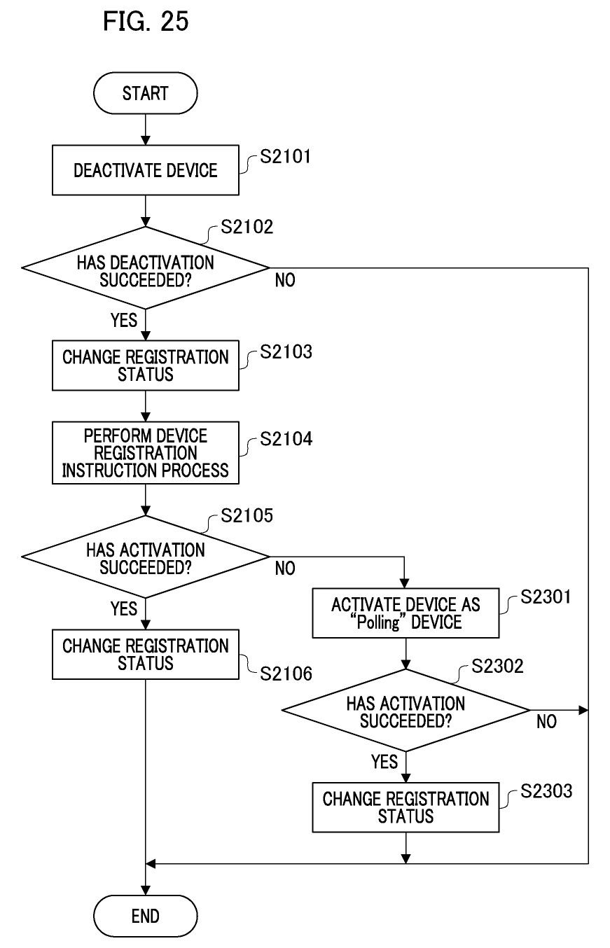

FIG. 25 is a flowchart showing the re-registration process for the image forming device in example 3. The processes to be executed by the monitoring device 105 are implemented by the CPU 303 of the monitoring device 105 executing a program stored in the memory 304. Processing steps identical to those in example 1 are denoted by reference signs similar to those in the re-registration determination process for the image forming device in example 1 (FIG. 22), and descriptions thereof will be omitted.

In S2105, the device management unit 503 determines whether or not activation has succeeded. When the activation has succeeded, the device management unit 503 performs the processing of S2106. On the other hand, when the activation has failed, the device management unit 503 performs the processing of S2301. In S2301, the device management unit 503 performs an activation process using a target device as an image forming device that does not have the self-monitoring function. The details of the activation process on the image forming device that does not have the self-monitoring function are similar to the registration process on the image forming device that does not have the self-monitoring function in FIG. 7. Through the processing of S2301, a device that has failed to activate as the image forming device using the proxy scheme is activated as the image forming device using the polling scheme. Thereby, even if the registration of the image forming device having the self-monitoring function fails, it can be re-registered again as the image forming device that does not have the self-monitoring function and monitoring can be continued.

In S2302, the device management unit 503 determines whether or not activation has succeeded. When the activation has succeeded, the device management unit 503 performs the processing of S2302. On the other hand, when the activation has failed, the device management unit 503 ends the present process. In S2303, the device management unit 503 changes the registration status 805, which is the device management information held by the data management unit 502, to “registered.”

Moreover, even if the registration of the device as the image forming device having the self-monitoring function fails and the process of activating the device as the image forming device that does not have the self-monitoring function is performed in S2301, there is a possibility that this process may fail and monitoring may stop. Even in such a case, any device may be made immediately available for monitoring. For example, a “register” button for activating a device as the device having the self-monitoring function may be displayed on the device detail screen shown in FIG. 21. Moreover, a “change to polling scheme” button may be displayed on the device detail screen so that the device may be activated as the device that does not have the self-monitoring function.

As described above, even if the monitoring method cannot be switched due to temporary network trouble when the monitoring method is switched, it is possible to continue monitoring by performing the activation process corresponding to the original monitoring method again.

### (Other Embodiments)

Embodiment(s) of the present disclosure can also be realized by a computer of a system or device that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., an application specific integrated circuit (ASIC)) for performing the functions of one or more of the above-described embodiment(s), and by a method performed by the computer of the system or device by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., a central processing unit (CPU) and a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-200317, filed November 18, 2024, which is hereby incorporated by reference in its entirety.

What is claimed is:

1. A relay device having a proxy server function of relaying communication between a device management service and a device, the relay device comprising:
a memory storing instructions; and
a processor executing the instructions causing the relay device to:
confirm whether a network environment of the device is a network environment capable of using a proxy scheme for receiving the device management service with the proxy server function of the relay device and validly set a re-registration process for re-registering a target device as a device having a self-monitoring function for the device management service with the device management service when the network environment is the network environment capable of using the proxy scheme;
determine whether a device using a polling scheme for receiving the device management service without using the proxy server function of the relay device has the self-monitoring function; and
perform the re-registration process for re-registering a device determined to have the self-monitoring function as the device having the self-monitoring function with the device management service when the re-registration process is validly set.

2. The relay device according to claim 1, wherein the processor determines that the network environment is the network environment capable of using the proxy scheme when a communication test with the device management service has succeeded in one or more devices among devices managed using the proxy scheme among devices managed by the relay device and validly sets the re-registration process.

3. The relay device according to claim 2, wherein the processor sets a device registration process including the re-registration process as a task and is able to set a task in which the re-registration process is validly set when it is determined that the network environment is the network environment capable of using the proxy scheme and unable to set the task in which the re-registration process is validly set when it is determined that the network environment is not the network environment capable of using the proxy scheme.

4. The relay device according to claim 2, wherein the processor determines whether or not the re-registration process for the device having the self-monitoring function is executable in accordance with a type of a device in which the communication test with the device management service has succeeded among the devices managed using the proxy scheme among the devices managed by the relay device when the re-registration process is validly set and performs an alarm display when there is a device having the self-monitoring function for which it is determined that the re-registration process is not executable.

5. The relay device according to claim 1,
wherein the process further executes an instruction causing the relay device to manage information of the device, and
wherein the processor manages a monitoring type and a device type for each device, the proxy scheme and a polling scheme in which the proxy server function is not used are included in the monitoring type, and switching information indicating that switching from the polling scheme to the proxy scheme is possible is stored in the monitoring type of the device having the self-monitoring function among devices that perform the polling scheme.

6. The relay device according to claim 5, wherein a button for providing a function of switching the monitoring type of the device from the polling scheme to the proxy scheme is displayed on a screen where information is displayed for each device when the switching information is stored in the monitoring type and the re-registration process for the device is performed when the button is selected.

7. The relay device according to claim 1,
wherein the re-registration process includes requesting the device management service to deactivate the device, performing a proxy setting with respect to the device after the deactivation is completed, and issuing a re-registration instruction to activate the device as the device having the self-monitoring function to the device management service, and
wherein the device is activated as a device that does not have the self-monitoring function in the device management service when the activation of the device has failed.

8. A control method of a relay device having a proxy server function of relaying communication between a device management service and a device, the method comprising:
confirming whether a network environment of the device is a network environment capable of using a proxy scheme for receiving the device management service with the proxy server function of the relay device and validly setting a re-registration process for re-registering a target device as a device having a self-monitoring function for the device management service when the network environment is the network environment capable of using the proxy scheme;
determining whether a device receiving the device management service without using the proxy server function of the relay device has the self-monitoring function for the device management service; and
performing the re-registration process for re-registering a device determined to have the self-monitoring function as the device having the self-monitoring function with the device management service when the re-registration process is validly set.

9. A non-transitory storage medium storing a control program of a relay device having a proxy server function of relaying communication between a device management service and a device causing a computer to perform each step of a control method of the relay device, the method comprising:
confirming whether a network environment of the device is a network environment capable of using a proxy scheme for receiving the device management service with the proxy server function of the relay device and validly setting a re-registration process for re-registering a target device as a device having a self-monitoring function for the device management service with the device management service when the network environment is the network environment capable of using the proxy scheme;
determining whether a device receiving the device management service without using the proxy server function of the relay device has the self-monitoring function for the device management service; and
performing the re-registration process for re-registering a device determined to have the self-monitoring function as the device having the self-monitoring function with the device management service when the re-registration process is validly set.
